(19) United States
(12) Patent Application Publication
(10) Pub. No.: US 2016/0245450 A1
(43) Pub. Date: Aug. 25, 2016

(54) HEAT INSULATING MATERIAL

(71) Applicant: TOYOTA JIDOSHA KABUSHIKI KAISHA, Toyota-shi (JP)

(72) Inventors: Taizo YOSHINAGA, Susono-shi (JP); Ryosuke MAEKAWA, Tahara-shi (JP)

(73) Assignee: TOYOTA JIDOSHA KABUSHIKI KAISHA, Toyota-shi (JP)

(21) Appl. No.: 15/051,008

(22) Filed: Feb. 23, 2016

(30) Foreign Application Priority Data
Feb. 24, 2015 (JP) 2015-034447

(51) Int. Cl. F16L 59/02

(52) U.S. Cl. CPC F16L 59/028

(57) ABSTRACT

It should be noted that when hollow nanosilica in an amount not less than a predetermined amount is incorporated into an AlCuFe-based quasicrystalline alloy, a heat conductivity lower than the heat conductivity predictable from the mixing ratio of the AlCuFe-based quasicrystalline alloy and the hollow nanosilica is obtained, a heat insulating material including an AlCuFe-based quasicrystalline alloy having mixed therein 17 mass % or more of hollow nanosilica is produced, wherein the heat insulating property is more enhanced.

### TECHNICAL FIELD

The present invention relates to a heat insulating material, more specifically, a heat insulating material obtained by mixing an AlCuFe-based quasicrystalline alloy and an oxide.

### BACKGROUND ART

Patent Document 1 discloses a heat insulating material obtained by mixing a hollow nanosilica particle and a binder resin. In addition, it is disclosed that the amount of the hollow nanosilica mixed is from 10 to 70 vol %.

Patent Document 2 discloses a quasicrystalline alloy disposed as a heat insulating and reflecting plate on the inner wall of a heating furnace.

Furthermore, in Patent Document 2, a quasicrystalline alloy containing from 5 to 45 atom % of one or more of Cu, Cr, Fe, Co, Ni, B, Mn, Ce, Si and Pd, and having a balance of Al and unavoidable impurities, is disclosed as a preferable example, and an Al₇₀Co₁₀Fe₁₃Cr₇ quasicrystalline alloy and an Al₆₅Cu₁₉Fe₈Cr₈ quasicrystalline alloy are disclosed in Examples.

The quasicrystal indicates a material structure that is neither amorphous nor crystalline, i.e., the quasicrystal indicates a material structure having a long-range order but no translational symmetry.

The level of heat conduction in a normal alloy is derived from the crystal's periodicity. However, as described above, the quasicrystal lacks perfect periodicity, and the heat conductivity of a quasicrystalline alloy is low. On this account, the quasicrystalline alloy is used as a heat insulating material.

### RELATED ART

### Patent Document

[Patent Document 1] Japanese Unexamined Patent Publication No. 2014-9261

[Patent Document 2] Japanese Unexamined Patent Publication No. 2002-310561

### SUMMARY OF THE INVENTION

### Problems to be Solved by the Invention

As regards the heat insulating material disclosed in Patent Document 1, the heat insulating property of the hollow nanosilica is very high, but since the heat insulating property of the resin binder is low, it is difficult to enhance the heat insulating property of the entire heat insulating material.

The quasicrystalline alloy reflects heat and therefore, when used as a heat insulating and reflecting plate on the inner wall of a heating furnace as disclosed in Patent Document 2, the thermal insulation efficiency in the furnace can be enhanced, but the quasicrystalline alloy itself sometimes comes short of the heat insulating property.

An object of the present invention is to provide a heat insulating material capable of sufficiently ensuring the heat insulating property even when a quasicrystalline alloy is contained.

### Means to Solve the Problems

As a result of intensive studies, the present inventors have found that when hollow nanosilica in an amount not less than a predetermined amount is mixed with an AlCuFe-based quasicrystalline alloy, a heat conductivity lower than the heat conductivity predicted from the mixing ratio of the AlCuFe-based quasicrystalline alloy and the hollow nanosilica is obtained.

The present invention has been accomplished based on the finding above, and the gist thereof is as follows.

<1> A heat insulating material comprising an AlCuFe-based quasicrystalline alloy having mixed therein 17 mass % or more of hollow nanosilica.

<2> The heat insulating material according to item <1>, wherein the hollow nanosilica is mixed in an amount of 40 mass % or less.

<3> The heat insulating material according to item <1> or <2>, wherein particles of the hollow nanosilica are uniformly dispersed among particles of the AlCuFe-based quasicrystalline alloy.

<4> The heat insulating material according to any one of items <1> to <3>, wherein the AlCuFe-based quasicrystalline alloy is composed Al, Cu, Fe and unavoidable impurities.

<5> The heat insulating material according to item <4>, wherein the AlCuFe-based quasicrystalline alloy contains from 24 to 26 atom % of Cu and from 12 to 13 atom % of Fe, with the remainder being Al and unavoidable impurities.

### Effects of the Invention

According to the present invention, hollow nanosilica in an amount not less than a predetermined amount is mixed with an AlCuFe-based quasicrystalline alloy, whereby a heat insulating material having more enhanced heat insulating property can be provided.

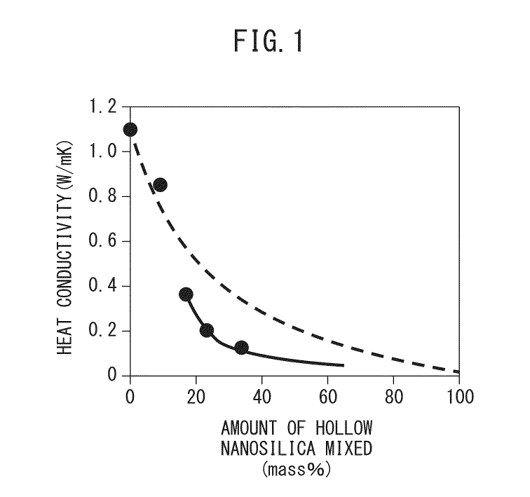

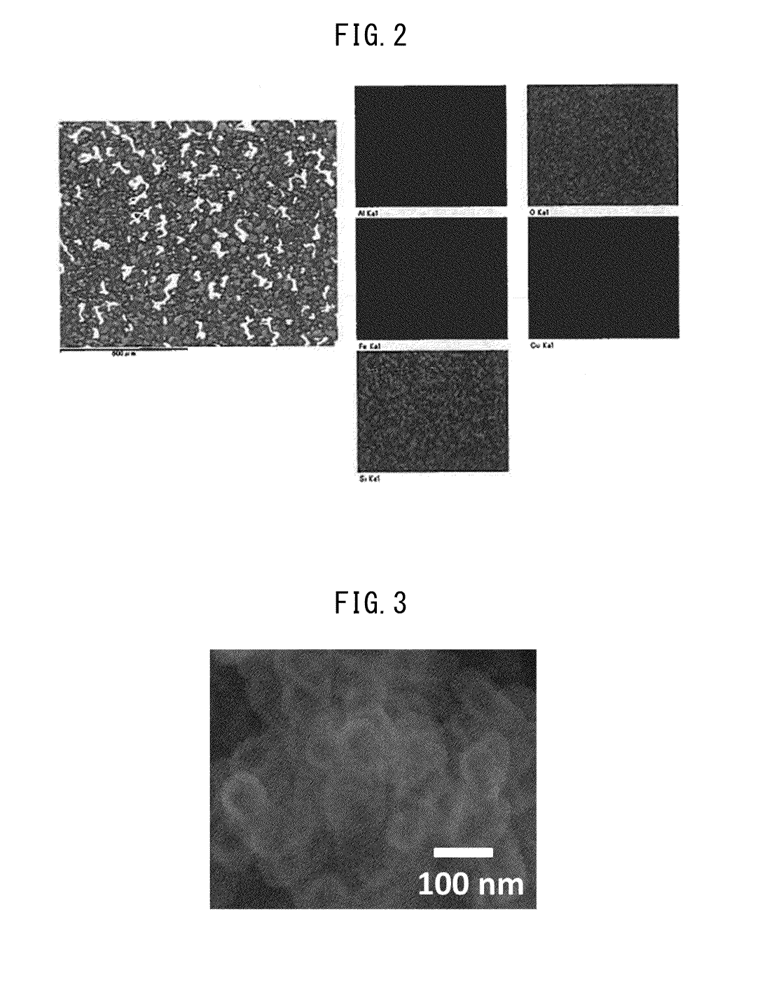

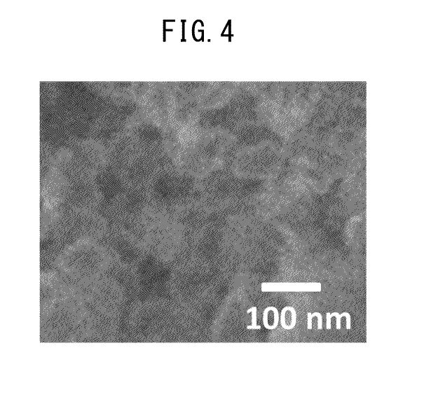

### BRIEF DESCRIPTION OF THE DRAWINGS

[FIG. 1] A graph illustrating the relationship between the mixing percentage (mass %) of hollow nanosilica in the heat insulating material and the heat conductivity.

[FIG. 2] A view showing one example of the analysis results by Energy Dispersive X-ray Spectroscopy (EDX) of the heat insulating material of the present invention.

[FIG. 3] A view showing one example of the Scanning Electron Microscope (SEM) observation results of hollow nanosilica particles.

[FIG. 4] A view showing the scanning electron microscope (SEM) observation result of a sintered body of AlCuFe quasicrystalline alloy particles and the hollow nanosilica particles shown in FIG. 3, which is one example of the heat insulating material of the present invention.

### MODE FOR CARRYING OUT THE INVENTION

The embodiments of the heat insulating material according to the present invention are described in detail below. The present invention is not limited to the following embodiments.

### (AlCuFe-Based Quasicrystalline Alloy)

The heat conductivity at room temperature of the AlCuFe-based quasicrystalline alloy is 1.1 W/mK. The AlCuFe-based quasicrystalline alloy as used in the present invention indicates an AlCuFe-based alloy at least partially having a quasicrystalline phase, i.e., in the AlCuFe-based quasicrystalline alloy of the present invention, at least part of structures has a long-range order but does not have translational symmetry. Due to this structure, the AlCuFe-based quasicrystalline alloy has a low thermal conductivity, despite being a metal material, and can be used as a heat insulating material.

### (Hollow/Nanosilica)

The hollow nanosilica has a heat conductivity of 0.02 W/mK at room temperature and is used as a heat insulating material. Since the hollow nanosilica is hollow, the heat conductivity of the hollow nanosilica is lower than the heat conductivity of massive silica (solid silica). Therefore, when hollow nanosilica is contained in a heat insulating material, the heat insulating property of the heat insulating material is improved.

### (Mixing Percentage of Hollow Silica: 17 Mass % or More)

The mixing percentage of the hollow nanosilica is 17 mass % or more relative to the mass of the entire heat insulating material. FIG. 1 is a graph illustrating the relationship between the mixing percentage (mass %) of hollow nanosilica in the heat insulating material and the heat conductivity. In FIG. 1, the solid line indicates the relationship between the mixing percentage (mass %) of hollow nanosilica and the neat conductivity. On the other hand, the dashed line indicates the relationship between the mixing percentage (mass %) of hollow silica and the heat conductivity, which is predictable from the Maxwell's rule of mixtures. The black dots (plots) represent measured values of the heat conductivity.

As described above, both the AlCuFe quasicrystalline alloy and the hollow nanosilica are a heat insulating material. When two or more kinds of heat insulating materials are mixed in this way, the heat conductivity of the whole of the mixed heat insulating material generally becomes a heat conductivity calculated by the Maxwell's rule of mixtures.

The heat conductivity calculated by the Maxwell's rule of mixtures indicates, for example, a heat conductivity k of the whole of a heat insulating material obtained by mixing substances, wherein if the heat conductivity of a substance 1 is k₁, the heat conductivity of a substance 2 is k₂, the mixing percentage of the substance 1 is x₁ and the mixing percentage of the substance 2 is (1−x₁), k is calculated according to the following formula (A):

k=k₂+[{3k₂(k₁−k₂)}/{2k₂+k₁−(k₁−k₂)·x₁}·x₁] (A)

When the relationship of formula (A) is shown graphically by assuming the substance 1 as hollow nanosilica and the substance 2 as an AlCuFe-based quasicrystalline alloy and plotting k on the ordinate and x₁ on the abscissa, the dashed line of FIG. 1 is obtained.

On the other hand, as shown by the solid line of FIG. 1, when the mixing percentage of hollow nanosilica is within the range of the present invention, i.e., 17 mass % or more, the heat conductivity of the entire heat insulating material becomes smaller than the heat conductivity predicted by the Maxwell's rule of mixtures, and an excellent heat insulating property is exhibited.

This is considered to result because when the mixing percentage of the hollow nanosilica is 17 mass % or more, due to phonon scattering generated at the interface of the AlCuFe-based quasicrystalline alloy and the hollow nanosilica, the heat conductivity is reduced below that predicted by the Maxwell's mixing rule. The mixing percentage of the hollow nanosilica may be 18 mass % or more, 19 mass % or more, or 20 mass % or more.

### (Mixing Percentage of Hollow Nanosilica: 40 Mass % or Less)

The mixture of the AlCuFe-based quasicrystalline alloy and the hollow nanosilica is preferably a sintered body or a coating. When the mixing percentage of the hollow nanosilica is 40 mass % or less, the strength of the sintered body or coating is kept from decreasing to cause cracking. For this reason, the mixing percentage of the hollow nanosilica is preferably 40 mass % or less. The mixing percentage of the hollow nanosilica is more preferably 38 mass % or less, 36 mass % or less, or 33 mass % or less.

(Material other than Hollow Nanosilica and AlCuFe-Based Quasicrystalline Alloy)

When the hollow nanosilica is mixed in a predetermined amount, the remainder of the heat insulating material is preferably composed of the AlCuFe-based quasicrystalline alloy and unavoidable impurities, but the heat insulating material may contain an alloy and/or an oxide other than the hollow nanosilica and the AlCuFe-based quasicrystalline alloy, as long as they do not affect the heat insulating property. The alloy other than the AlCuFe-based quasicrystalline alloy is, for example, an alloy that does not deteriorate the heat insulating property, i.e., an alloy having a quasicrystalline phase, other than the AlCuFe-based quasicrystalline alloy. The oxide other than the hollow nanosilica is, for example, alumina, magnesia or zircon each having a heat insulating property. An oxide that is a hollow nanoparticle is better.

(State in which AlCuFe-Based Quasicrystalline Alloy and Hollow Nanosilica are Present)

The reduction of the heat conductivity to below that predicted by the Maxwell's mixing rule is considered, as described above, to be attributable to phonon scattering generated at the interface of the AlCuFe-based quasicrystalline alloy and the hollow nanosilica. Therefore, for increasing the area of the interface, both the AlCuFe-based quasicrystalline alloy and the hollow nanosilica are preferably present in a particle state. In addition, particles of the hollow nanosilica are preferably dispersed uniformly among particles of the AlCuFe quasicrystalline alloy.

FIG. 2 is a view showing one example of the analysis results by Energy Dispersive X-ray Spectroscopy (EDX) of the heat insulating material of the present invention. The heat insulating material shown in FIG. 2 is a heat insulating material obtained by mixing 33 mass % of hollow nanosilica with an AlCuFe-based quasicrystalline alloy and sintering the mixture into a sintered body.

The expression “particles of the hollow nanosilica are dispersed uniformly among particles of the AlCuFe quasicrystalline alloy” indicates that, as shown in FIG. 2, hollow nanosilica is present.

The AlCuFe-based quasicrystalline alloy particle and the hollow nanosilica particle, which are mixed, are then preferably sintered. Sintering causes particles of the AlCuFe-based quasicrystalline alloy, particles of the hollow nanosilica, and a particle of the AlCuFe-based quasicrystalline alloy and a particle of the hollow nanosilica, to adhere to each other, and the shape of a mixture is maintained.

The form of the mixture after sintering may be a sintered body by itself or may be a coating attached to or deposited on a substrate.

### (Particle Diameters of AlCuFe-Based Quasicrystalline Alloy Particle and Hollow Nanosilica Particle)

Both the AlCuFe-based quasicrystalline alloy particle and the hollow nanosilica particle preferably have a particle diameter of 10 to 900 nm. A particle diameter in the range of 10 to 900 nm is advantageous to the formation of a sintered body or a coating.

FIG. 3 is a view showing one example of the Scanning Electron Microscope (SEM) observation results of hollow nanosilica particles. FIG. 4 is a view showing the Scanning Electron Microscope (SEM) observation result of a sintered body of AlCuFe quasicrystalline alloy particles and the hollow nanosilica particles shown in FIG. 3, which is one example of the heat insulating material of the present invention.

As shown in FIGS. 3 and 4, both the AlCuFe-based quasicrystalline alloy particle and the hollow nanosilica particle are more preferably adjusted to have a particle diameter of 30 to 100 nm. By adjusting the particle diameters of the AlCuFe-based quasicrystalline alloy particle and the hollow nanosilica particle to fall in the same range, segregation is less likely to occur at the time of mixing, and uniform mixing is readily achieved. In addition, when the particle diameters are from 30 to 100 nm, the strength of the sintered body is enhanced.

### (Composition of AlCuFe-Based Quasicrystalline Alloy)

As long as the AlCuFe-based quasicrystalline alloy contains Al, Cu, Fe and unavoidable impurities and at least partially has a quasicrystalline phase, the composition thereof is not particularly limited. Respective contents of Al, Cu and Fe for at least partially forming a quasicrystalline phase differ depending on the production method and production conditions of the AlCuFe-based quasicrystalline alloy. The content range of each of Al, Cu and Fe described below indicates a preferable range.

(Cu: from 24 to 26 Atom %)

The Cu content is preferably from 24 to 26 atom %. When the Cu content is 24 atom % or more, a quasicrystalline phase readily develops. On the other hand, when the Cu content is 26 atom % or less, a crystalline phase is less likely to develop. The upper limit of the Cu content is more preferably 25.5 atom %, 25.0 atom %, or 24.5 atom %.

(Fe: from 12 to 13 Atom %)

The Fe content is preferably from 12 to 13%. When the Fe content is 12 atom % or more, a quasicrystalline phase readily develops. On the other hand, when the Fe content is 13 atom % or less, a crystalline phase is less likely to develop. The upper limit of the Fe content is more preferably 12.5 atom %.

(One or More Selected from V, Mo, Ti, Zr, Nb, Cr, Mn, Ru, Rh, Ni, Mg, W, Si, and Rare Earth Elements)

The AlCuFe-based quasicrystalline alloy of the present invention may further contain one or more selected from V, Mo, Ti, Zr, Nb, Cr, Mn, Ru, Rh, Ni, Mg, W, Si, and rare earth elements, in addition to Al, Cu and Fe. Even when the alloy contains such an element, the effects of the present invention are not impaired.

(Total of Contents of V, Mo, Ti, Zr, Nb, Cr, Mn, Ru, Rh, Ni, Mg, W, Si, and Rare Earth Elements: from More than 0 Atom % to 10 Atom %)

In the case of further containing one or more members selected from V, Mo, Ti, Zr, Nb, Cr, Mn, Ru, Rh, Ni, Mg, W, Si, and rare earth elements, in addition to Al, Cu and Fe, the total of the contents of these elements is preferably from more than 0 atom % to 10 atom %. Within this range, the heat insulating property and the characteristic properties other than heat insulating property are not deteriorated.

### (Remainder: Al and Unavoidable Impurities)

The AlCuFe-based quasicrystalline alloy is an alloy based on Al, and the remainder consists of Al and unavoidable impurities. The content of unavoidable impurities is preferably 1 atom % or less. The element representative of the unavoidable impurity element is O.

### (Production Method of AlCuFe-Based Quasicrystalline Alloy)

The production method of the AlCuFe-based quasicrystalline alloy is not particularly limited, but a solid-phase diffusion method is preferred in that the AlCuFe-based quasicrystalline alloy is obtained as a particle.

### (Solid-Phase Diffusion Method)

The solid-phase diffusion method is a method of mixing an Al powder, a Cu powder and an Fe powder and heating the mixture. The Al powder, Cu powder and Fe powder are weighed to give a desired composition when formed into an AlCuFe-based quasicrystalline alloy, and mixed.

The heating temperature is not particularly limited as long as it is a temperature high enough to cause mutual diffusion of Al, Cu and Fe. The temperature is preferably from 670 to 750° C. When the temperature is 670° C. or more, the Al powder melts, and solid phases Cu and Fe present in the Al solution mutually diffuse efficiently among Al, Cu and Fe. On the other hand, when the temperature is 750° C. or less, even in the case where a crystal is produced, the crystal is not coarsened. The heating temperature is more preferably from 690 to 710° C.

The particle diameters of the Al powder, Cu powder and Fe powder are not particularly limited as long as the particle diameter at the time of mutual diffusion of Al, Cu and Fe into each other and formation of an AlCuFe-based quasicrystalline alloy is a size enabling trouble-free mixing with the hollow nanosilica. The particle diameter of the Al powder is preferably from 1 to 5 μm, the particle diameter of the Cu powder is preferably from 0.5 to 3 μm, and the particle diameter of the Fe powder is preferably from 3 to 7 μm.

When the particle diameter of the Al powder is 1 μm or more, the Al powder is prevented from being oxidized with slight oxygen. On the other hand, when the particle diameter of the Al powder is 5 μm or less, the Al powder rapidly melts at the time of heating, and the particle diameter of the AlCuFe-based quasicrystalline alloy formed becomes a size enabling trouble-free mixing with the hollow nanosilica. The particle diameter of the Al powder is more preferably from 2 to 4 μm.

When the particle diameter of the Cu powder is 0.5 μm or more, the Cu powder is prevented from being oxidized with slight oxygen. On the other hand, when the particle diameter of the Cu powder is 3 μm or less, Al, Cu and Fe mutually diffuse at the time of heating, and the particle diameter of the AlCuFe-based quasicrystalline alloy formed becomes a size enabling trouble-free mixing with the hollow nanosilica. The particle diameter of the Cu powder is more preferably from 0.5 to 2 μm.

When the particle diameter of the Fe powder is 3 μm or more, the Fe powder is prevented from being oxidized with slight oxygen. On the other hand, when the particle diameter of the Fe powder is 7 μm or less, Al, Cu and Fe mutually diffuse at the time of heating, and the particle diameter of the AlCuFe-based quasicrystalline alloy formed becomes a size enabling trouble-free mixing with the hollow nanosilica. The particle diameter of the Fe powder is more preferably from 4 to 6 μm.

In order to prevent oxidation of the Al powder, Cu powder and Fe powder during heating, the heating is preferably performed in a reducing atmosphere, more preferably a hydrogen atmosphere. The pressure of the atmosphere is not particularly limited as long as Al, Cu and Fe mutually diffuse into each other, but the pressure is preferably from 0.9 to 1.1 atm. When the pressure is 0.9 atm or more, intrusion of a large amount of air into the heating vessel to oxidize the Al powder, Cu powder and Fe powder does not occur. On the other hand, when the pressure is 1.1 atm or less, the Al powder, Cu powder and Fe powder can be heated without using a pressure vessel for the heating vessel. The pressure is more preferably from 0.95 to 1.05 atm.

The heating time may be appropriately determined according to the amounts of the Al powder, Cu powder and Fe powder but is preferably from 30 minutes to 3 hours. When the heating time is 30 minutes or more, mutual diffusion of Al, Cu and Fe into each other starts. On the other hand, when the heating time is 3 hours or less, useless heating is not allowed to continue after the completion of mutual diffusion of Al, Cu and Fe into each other. The heating time is more preferably from 1.5 to 2.5 hours.

In the case where the AlCuFe-based quasicrystalline alloy contains one or more members selected from V, Mo, Ti, Zr, Nb, Cr, Mr, Ru, Rh, Ni, Mg, W, Si, and rare earth elements, the powder of such an element is further added to give a desired composition, and mixed, and the mixture is heated. The particle diameter of the powder of such an element may be appropriately determined by taking into account the diffusibility of the element, so that the particle diameter of the AlCuFe-based quasicrystalline alloy formed can be a size enabling trouble-free mixing with the hollow nanosilica, but the particle diameter is preferably from 0.5 to 7 μm. When the particle diameter is 0.5 μm or more, such an element is prevented from being oxidized with slight oxygen. On the other hand, when the particle diameter is 7 μm or less, such an element, Al, Cu and Fe mutually diffuse and at the same time, the particle diameter of the AlCuFe-based quasicrystalline alloy formed becomes a size enabling trouble-free mixing with the hollow nanosilica.

As regards the quasicrystalline alloy, Patent Document 2 may also be referred to.

### (Production Method of Hollow Nanosilica)

The production method of the hollow nanosilica is not particularly limited and may be a conventional method. Examples thereof include an organic bead template method, an emulsion template method, a spray pyrolysis method, and an electrostatic spray method.

As regards the hollow nanosilica, Patent Document 1 may also be referred to.

### (Production Method of Heat Insulating Material of the Present Invention)

The production method of heat insulating material of the present invention is not particularly limited as long as a predetermined amount of hollow nanosilica can be mixed with an AlCuFe-based quasicrystalline alloy. In the case of intending to form the mixed AlCuFe-based quasicrystalline alloy and hollow nanosilica as a sintered body, for example, a spark plasma sintering (SPS) method is preferred. In the case of intending to form the mixture as a coating, for example, thermal spraying is preferred.

### (Spark Plasma Sintering (SPS))

As with a hot press sintering method, the spark plasma sintering method is a kind of a solid compression/sintering method and is a processing method of sintering a to-be-processed material by mechanical pressure application and pulse-current heating.

The heating temperature is preferably from 700 to 800° C. When the heating temperature is 700° C. or more, the AlCuFe-based quasicrystalline alloy particle and the hollow alumina particle can be sintered. On the other hand, when the heating temperature is 800° C. or less, the progress of crystallization of the AlCuFe-based quasicrystalline alloy or the coarsening of crystal grain does not occur. The heating temperature is more preferably from 730 to 770° C.

The pressure applied is preferably from 20 to 100 MPa. When the pressure is 20 MPa or more, the AlCuFe-based quasicrystalline alloy particle and the hollow alumina particle can be formed into a compact. When the pressure is 100 MPa or less, use of a large-sized mold is not needed so as to ensure the pressure resistance of a mold. The pressure applied is more preferably from 30 to 70 MPa.

The time for which heat and pressure are applied, i.e., the molding time, may be appropriately determined according to the total amount of the AlCuFe-based quasicrystalline alloy particle and the hollow nanosilica particle. The molding time is preferably from 10 to 60 minutes. When the molding time is 10 minutes or more, the AlCuFe-based quasicrystalline alloy particle and the hollow nanosilica particle are sintered. On the other hand, when the molding time is 60 minutes or less, useless molding is not allowed to continue after the completion of sintering. The molding time is more preferably from 20 to 40 minutes.

In the case of forming a sintered body by a method other than the spark plasma sintering method, the heating temperature, the pressure applied and the molding time may be determined based on the above-described conditions in the spark plasma sintering method.

### (Thermal Spraying)

In the case where a coating of the heat insulating material of the present invention is formed by thermal spraying, the AlCuFe-based quasicrystalline alloy particle and the hollow nanosilica particle are thermally sprayed at the same time.

The temperature of the AlCuFe-based quasicrystalline alloy particle and hollow nanosilica particle at the time of thermal spraying is preferably from 700 to 800° C. When the temperature is 700° C. or more, the heat insulating material obtained by thermally spraying the AlCuFe-based quasicrystalline alloy particle and hollow nanosilica particle on a substrate becomes a sintered coating. On the other hand, when the temperature is 800° C. or less, the progress of crystallization of the AlCuFe-based quasicrystalline alloy or the coarsening of crystal grain does not occur. The temperature is more preferably from 730 to 770° C.

The temperature of the substrate may be appropriately determined according to the material of the substrate. The material of the substrate is not particularly limited, but a metal material is generally used.

In the case of forming a coating by a method other than the thermal spraying method, the temperature of the AlCuFe-based quasicrystalline alloy particle and the hollow nanosilica particle, etc. may be determined based on the above-described conditions in the thermal spraying method.

### EXAMPLES

The present invention is described in greater detail below by referring to Examples. The present invention is not limited to the conditions used in the following Examples.

### (Production of Sample)

A particle of an alloy having a composition of Al₆₃Cu_{24.5}Fe_{12.5} was prepared as the AlCuFe-based quasicrystalline alloy. The heat conductivity of this Al₆₃Cu_{24.5}Fe_{12.5} alloy was 1.1 W/mK at ordinary temperature.

In addition, a hollow nanosilica particle was prepared. The heat conductivity of this hollow nanosilica was 0.02 W/mK at ordinary temperature.

The Al₆₃Cu_{24.5}Fe_{12.5} alloy particle and the hollow nanosilica particle were mixed and sintered by the Spark Plasma Sintering (SPS) method to form a heat insulating material. In the particles obtained, the amount of the hollow nanosilica particle mixed was 0, 9, 17, 23 and 33 mass %, and the remainder was an Al₆₃Cu_{24.5}Fe_{12.5} alloy in each particle. The amount of unavoidable impurities was not more than the measurement limit. The heating temperature was 750° C., the pressure applied was 50 MPa, and the pressure application time was 30 minutes.

### (Evaluation of Sample)

Each sample was measured for the heat conductivity at ordinary temperature. In addition, the heat conductivity in each sample predicted from the Maxwell's rule of mixtures was calculated according to formula (A). For reference, the density of each sample was measured.

The results are shown in Table 1.

TABLE 1

| | | Measured Value | | |
|---|---|---|---|---|
| | Amount of Hollow | of Heat | | |
| Sample | Nanosilica Mixed | Conductivity | Density | |
| No. | (mass %) | (W/mK) | (g/cm³) | Remarks |
| 1 | 0 | 1.1 | 4.29 | Comparative |
| | | | | Example |
| 2 | 9 | 0.85 | 3.72 | Comparative |
| | | | | Example |
| 3 | 17 | 0.4 | 2.94 | Invention |
| 4 | 23 | 0.2 | 2.25 | Invention |
| 5 | 33 | 0.15 | 1.95 | Invention |

The results in Table 1 are depicted in FIG. 1. In FIG. 1, the dashed line represents the heat conductivity predicted from the Maxwell's rule of mixtures. As apparent from FIG. 1, the measured values of heat conductivity of Sample Nos. 3 to 5 where the amount of the hollow nanosilica mixed is 17 mass % or more, was significantly lower than the thermal conductivity predicted from the Maxwell's rule of mixture.

From these results, the effects of the present invention could be confirmed.

### INDUSTRIAL APPLICABILITY

According to the present invention, a heat insulating material containing an AlCuFe-based quasicrystalline alloy, where heat insulating property is more enhanced, can be provided. Therefore, the present invention has high industrial applicability.

1. A heat insulating material comprising an AlCuFe-based quasicrystalline alloy having mixed therein 17 mass % or more of hollow nanosilica.

2. The heat insulating material according to claim 1, wherein said hollow nanosilica is mixed in an amount of 40 mass % or less.

3. The heat insulating material according to claim 1, wherein particles of said hollow nanosilica are uniformly dispersed among particles of said AlCuFe-based quasicrystalline alloy.

4. The heat insulating material according to any one of claim 1, wherein said AlCuFe-based quasicrystalline alloy comprises Al, Cu, Fe and unavoidable impurities.

5. The heat insulating material according to claim 4, wherein said AlCuFe-based quasicrystalline alloy contains from 24 to 26 atom % of Cu, from 12 to 13 atom % of Fe, and a balance of Al and unavoidable impurities.

6. The heat insulating material according to claim 2, wherein particles of said hollow nanosilica are uniformly dispersed among particles of said AlCuFe-based quasicrystalline alloy.

7. The heat insulating material according to any one of claim 2, wherein said AlCuFe-based quasicrystalline alloy comprises Al, Cu, Fe and unavoidable impurities.

8. The heat insulating material according to any one of claim 3, wherein said AlCuFe-based quasicrystalline alloy comprises Al, Cu, Fe and unavoidable impurities.

9. The heat insulating material according to claim 7, wherein said AlCuFe-based quasicrystalline alloy contains from 24 to 26 atom % of Cu, from 12 to 13 atom % of Fe, and a balance of Al and unavoidable impurities.

10. The heat insulating material according to claim 8, wherein said AlCuFe-based quasicrystalline alloy contains from 24 to 26 atom % of Cu, from 12 to 13 atom % of Fe, and a balance of Al and unavoidable impurities.
